(19) United States
(12) Patent Application Publication
(10) Pub. No.: US 2024/0030839 A1
(43) Pub. Date: Jan. 25, 2024

(54) ETERNAL GENERATOR

(71) Applicant: KAM WAH PANG, UPLAND, CA (US)

(72) Inventor: KAM WAH PANG, UPLAND, CA (US)

(21) Appl. No.: 18/452,527

(22) Filed: Aug. 19, 2023

(51) Int. Cl. H02N 11/00

(52) U.S. Cl. CPC H02N 11/002; H02N 11/006

(57) ABSTRACT

The Eternal Generator is for creating unlimited energy for human use.

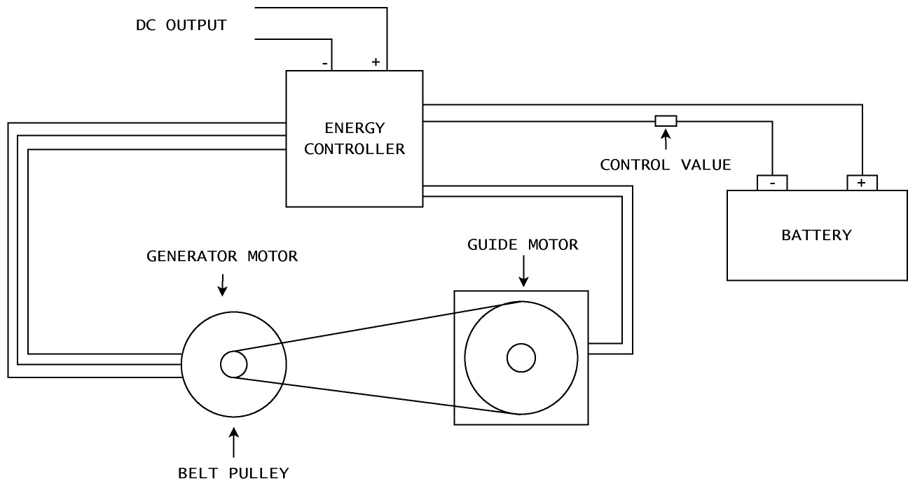

### BRIEF SUMMARY OF INVENTION

The Eternal Generator is for creating unlimited energy for human use.

### BRIEF DESCRIPTION OF SEVERAL VIEWS OF THE DRAWING

Drawing is as labeled.

### DETAILED DESCRIPTION OF INVENTION

A generating energy system that uses a guide motor and a pulley belt that drives the alternator to create energy, starting from a battery to turn infinitely. The energy controller controls the guide motor and generator motor to charge the battery and produce the load energy at the same time. When the battery reaches full charge, the controller could stop the guide motor and alternator or choose to continue running to create more energy.

The theory is to consume less energy by using a low energy motor to drive a high efficiency motor to create more energy for other use.

For example, use a high torque motor 300 W to drive a high efficiency motor at 1000 W that will create more energy for human use.

1. A method of generating energy comprising:
starting a high torque motor from a battery and pulley belt controlled by an energy controller to drive a high efficiency alternator.
